(19) United States
(12) Patent Application Publication
(10) Pub. No.: US 2022/0229318 A1
(43) Pub. Date: Jul. 21, 2022

(54) MATERIALS AND METHODS USED WITH PLASMON RESONANCE DETECTION TECHNIQUES

(71) Applicant: Conrad Rial, Brampton (CA)

(72) Inventor: Conrad Rial, Brampton (CA)

(21) Appl. No.: 17/232,641

(22) Filed: Apr. 16, 2021

Related U.S. Application Data
(60) Provisional application No. 63/065,076, filed on Aug. 13, 2020.

(51) Int. Cl. G02F 1/09; G01N 15/14

(52) U.S. Cl. CPC G02F 1/09; G02F 2203/10; G01N 15/1436

(57) ABSTRACT

Improved multilayered magneto-optic-plasmonic (“MOP”) films that are used in connection with surface plasmon detection that have a first layer comprising titanium, a second layer selected from a group consisting of gold and silver, a third layer comprising cobalt, and a fourth layer comprising gold are disclosed. In an embodiment, the film has a first titanium layer with a thickness of approximately 2 nm, a second gold layer with a thickness of 35 nm, a layer of cobalt having a thickness of approximately 8 nm and a fourth gold base layer having a thickness of approximately 10 nm.

### REFERENCE TO RELATED APPLICATIONS

The Applicant claims the benefit of U.S. Application No. 63/065,076 that was filed on Aug. 13, 2020.

### BACKGROUND OF THE INVENTION

The present invention relates to improved materials and methods used in connection with detection techniques that measure changes of surface plasmons and is particularly applicable to biosensors. The optical properties of plasmon resonant nanostructures allow for the detection of biological elements using relatively simple optical characterization techniques.

Plasmonic biosensors generally use thin metallic films or individual inorganic plasmon resonant nanostructures on which target molecules are attached. The most widely used type of plasmonic biosensor is referred to as a surface plasmon resonance (SPR) sensor, which uses a metallic film-based element that allows interactions between biomolecules which are then detected using optical techniques. Biological molecules such as antibodies or antigens may be bound to a first surface of such a metallic film that borders a fluid chamber within a flow cell. Molecules in a medium passing through the flow cell can interact and bind with the molecules attached to a first surface of the film. This attachment alters the opposite surface of the film and the alteration may be detected using optical techniques.

Surface plasmons are coherent delocalized electron oscillations that exist at the interface between any two materials where the real part of the dielectric function changes sign across the interface. Typically, a metal-dielectric interface, such as a metal sheet and air or fluid, is employed. The charge motion in a surface plasmon creates electromagnetic fields outside (as well as inside) the metal. The total excitation, including both the charge motion and associated electromagnetic field, is called either a “surface plasmon polariton” at a planar interface, or a “localized surface plasmon” for the closed surface of a small particle.

Detecting diseases occurring at the early stages due to infections caused by harmful bacteria and viruses in hospitals and clinics, is a huge challenge, because of the lack of label-free highly sensitive, affordable, and portable biosensors. Surface plasmon resonance (SPR) modulation configurations have been proposed as a solution, and, for example, the use of an external modulation, e.g., mechanical or phase-modulated SPR sensing may improve the signal-to-noise ratio (SNR) in such systems to increase detection limits. Another detection technique uses a transition metal dichalcogenides-based material. However, the sensitivity and detection limits are still low with this technique and the magnetic activity has not been fully tested in such proposed configurations.

Magneto-optic-plasmonic (MOP) material combination consisting of nanostructured multilayer combination of 3-d transition ferromagnetic (FM), non-magnetic (NM) metals, and dielectrics are relatively new materials, now used and being studied for developing new types of sensors.

When a material possesses an abundance of free electrons and a thin layer of them is brought into contact with a dielectric probing medium and then excited using an optical radiation at a specified angle using a coupling medium such as a grating or prism, these electrons start to oscillate in-plane-parallel to the multilayer-prism/dielectric interface. These oscillations (also known as collective oscillations of conduction electrons) then create enhanced transverse electromagnetic (EM) waves which are also known as surface plasmon polaritons (SPPs)). These waves are typically concentrated at the interface of two media, and extend beyond the sensor boundary, and are highly sensitive to the changes in optical properties of the probing media. When probing samples such as gases (e.g., air, Helium, etc.) or liquid media (e.g., urine, serum, saliva, etc.) are brought into proximity to the highly sensitive magneto-optic-SPR (MOSPR) sensor surface, the optical interaction between them provides several interesting physical and chemical information. This information can help detect contagious diseases at the early stage, can be used to monitor humidity and NO₂ in air, test food quality, and so on. However, many existing conventional SPR sensors cannot detect these changes due to the limited sensitivity and detection limits as they have already reached the limit of detection.

A common metal film used for such detection is made from gold because it produces SPRs that can be interrogated using visible wavelengths of light. Gold is also relatively inert as it is not prone to oxidation and can be adapted with molecular linkers using gold-thiol interactions or through conventional adsorption techniques.

The film SPR sensing mechanism used in the invention is based on the property of the SPR which is highly sensitive to the refractive index (RI) of the medium that is in direct contact with the metal film, which, in the case of biosensing is an aqueous solution such as water. Surface plasmon polarization are very sensitive to slight perturbations within the skin depth of the film and because of this, they are often used to probe inhomogeneities of a surface.

A common SPR sensing detection method used involves a receptor, such as an antibody, drug target, or oligonucleotide that is immobilized to a film surface. Next a baseline response of the SPR instrument is measured using a photodetector, and the change in the SPR location is monitored over time as a target analyte is introduced through a flow cell As the analyte contacts the film surface on which the receptors are fixed, the SPR response over time is used to determine parameters of the binding or other interaction. An advantage of film SPR studies is that binding interactions can be measured without additional labels or modifications.

In alternative techniques, the magneto-optic-plasmonic (MOP) configurations have been proposed and demonstrated as potential biosensors in various excitation conditions, e.g., wavelength, incident angle, and layer compositions. In these configurations, the optical modulation arises from the simultaneous excitation of MO effects and SPR in multilayer structures that have both plasmonic and MO activities

### BRIEF SUMMARY OF THE INVENTION

The present invention is directed to new configurations of materials used in connection with detection using surface plasmon resonance (SPR), reflectance versus incident angle and transverse magneto-optic Kerr effect (“T-MOKE”) versus incident angle. The MOP sensor configuration using magnetic activity and optimized prism having either Ti/Au/Co/Au or Ti/Ag/Co/Au multilayers at different excitation wavelengths (632.8 and 785 nm) that has enhanced sensitivity and detection limits when compared to existing SPR sensors.

The present invention specifically accordingly relates to two new magneto-optic-plasmonic (MOP) configurations: A first configuration having the layers of a metallic sheet arranged in the following order Ti/Au/Co/Au; and a second configuration having the layers arranged in the following order Ti/Ag/Co/Au, wherein in both embodiments titanium is used on the bottom surface (the surface closer to the prism where the optical signal is provided) and the detection system is measured using an excitation wavelength of 632.8 and 780 nm in air. In embodiments, the thickness of the layers is modified and also provided with a polycarbonate layer over the top gold layer.

Accordingly, a first configuration as set forth in Table 1 uses a base layer made from gold (Au) and having a thickness of approximately 35 nm. Next a cobalt (Co) magneto-optical layer is deposited on the gold base layer having a thickness between 4 and 8 nm. The top layer of this first configuration is a gold layer (Au) having a thickness of 8 nm.

TABLE 1

| | | | | |
|---|---|---|---|---|
| Au(8)/Co(4)/Au(35)/Ti(2) | xx × | xx × | xx × | xx × |
| | 10⁻⁵ | 10⁻⁶ | 10⁻⁵ | 10⁻⁶ [symbol] 14 [symbol] |

[symbol]

indicates data missing or illegible when filed

A second configuration, as shown in Table 2 uses a layer made from titanium (Ti) having a thickness of approximately 2 nm and a based layer made from a silver layer (Ag) having a thickness of approximately 35 nm. Next a cobalt (Co) magneto-optical layer is deposited on the Silver (Ag) base layer having a thickness between 2 and 4 nm and a top layer is made from a gold layer (Au) having a thickness of 8 nm.

TABLE 2

| | | | | |
|---|---|---|---|---|
| Au(8)/Co(4)/Ag(35)/Ti(2) | 8.30 × | 1.55 × | 1.76 × | 1.67 × |
| | 10⁻⁵ | 10⁻⁶ | 10⁻⁵ | 10⁻⁶ [symbol] 14 [symbol] |

[symbol]

indicates data missing or illegible when filed

In a further sensor configuration as shown in Table 3, the layers consist of a 2 nm Ti and index matching liquid (IMD), 35 nm of Ag, 2 nm of Co, and a 4 nm outer plasmonic Au layer. In yet further configurations, each of the configurations recited above are provided with a polycarbonate layer over the gold layer that is adjacent to the flow cell. The polycarbonate layer has a thickness between 2 nm and 15 nm.

TABLE 3

| | | | | |
|---|---|---|---|---|
| Au(4)/Co(2)/Ag(35)/Ti(2) | — | — | 2.05 × | 7.10 × |
| | | | 10⁻⁵ | 10⁻⁶ [symbol] This work [symbol] |

[symbol]

indicates data missing or illegible when filed

Magneto-optic-plasmonic (MOP) structures—a class of devices that have been considered important for enhanced surface plasmon resonance (SPR) and transverse magneto-optic Kerr effect (T-MOKE) responses are particularly useful in sensing applications. The present invention discloses the reflectance and T-MOKE effects shown by new structures comprised of Ti/Au/Co/Au and Ti/Ag/Co/Au and compare the respective performance at a wavelength, λ=780 nm. For simplicity in terms of fabrication, assembly and handling purposes, the Kretschmann geometry is used for exciting SPRs. In the Kretschmann configuration, light is coupled into the metallic film by a glass prism that facilitates total internal reflection (TIR) of the input beam at the metallic film/air interface. Accordingly, in the Kretschmann geometry, the surface plasmons are excited at the interface of a metallic multilayer and air, the conventional probed medium when used for sensing applications. These surface plasmons are oscillations of the electrons, and they travel with distinct frequency and wave vector (longitudinal wave) along with the interface. The displacement of the surface plasmons with respect to positive ion is parallel to the propagation, and they are excited using incident optical radiation at a specific wavelength, and at an oblique angle for wave-vector matching, p-polarized light excites surface plasmons and form surface plasmon polaritons (SPP). The Kretschmann configuration is advantageous because the optical path of the sensing platform is totally contained on the backside of the sensor surface, which facilitates the use of flow cells on the opposite side of the sensor surface.

The surface plasmon waves are confined at the surface of the sensor, and this confinement makes these waves very sensitive to the dielectric environment within the region the evanescent wave field extends. The addition of the magnetic material yields a magneto-optic enhancement, which is a unique feature of T-MOKE configuration. SPR sensors with a magnetic layer are also referred to magneto-optic SPR (MO-SPR) sensors.

Most of the previous studies have been focused on studying reflectance and T-MOKE response in bilayers of Au/Co, Au/Fe, Ag/Co or Ag/Fe, where the Au or Ag act as the plasmonic layer and Co or Fe as the magneto-optic component of the MOP configuration. In the present invention, the performance between new configurations using Au-rich (Ti/Au/Co/Au, Configuration A) and Ag-rich (Ti/Ag/Co/Au, Configuration B) multilayers is disclosed. In an embodiment, the response curves are measured in air as the sensing medium and compared to models, demonstrate an improved performance of the Ag-rich sensors over Au-rich sensors.

Both new configurations show an enhancement of the T-MOKE signal over the SPR signal. The second configuration, referred to as Configuration B, showed higher SPR and T-MOKE response over the first configuration, Configuration A, possibly due to the low loss and higher plasmonic properties of Ag over Au. The T-MOKE based sensor shows improvements in quality factor by over 2× compared to that of SPR. The magneto-optic SPR sensitivity of the sensor obtained shows an improvement by 3× over the SPR sensitivity.

### BRIEF DESCRIPTION OF THE DRAWINGS

FIG. 1 is a schematic drawing of a biosensor using SPR according to the invention.

FIG. 2 is a schematic drawing of a flow cell and the adjacent plasmonic structure.

FIG. 3 is a comparison of relative sensitivity of a SPR sensor and a MOSPR sensor according to the invention across different incident angles at a wavelength of 632.8 nm using a film Ag-based Ti/AG/Co (2 nm)/Au 8 nm (air to Helium).

FIG. 4 is a comparison of the sensitivity of a SPR sensor and a MOSPR sensor according to the invention across different incident angles at a wavelength of 785 nm using a film having a thickness of the top Au layer of 8 nm.

FIG. 5 is a graph showing the change in reflectivity using an excitation wavelength at 785 nm and the thickness of top Au is 4 nm.

FIG. 6 is a graph showing SPR/MOSPR sensitivity vs. the incident angle, expressed in %/RIU for an optimized sensor configuration of Ag-based film comprising Ti/Ag/Co (2 nm)/Au (4 nm)/(air to Helium).

FIG. 7A depicts experimentally obtained SPR and normalized data for three, layered films and the predicted reflectivity Rp.

FIG. 7B depicts results for three, layered films comparing the incident angle and the TMOKE or MOSPR percent.

### DETAILED DESCRIPTION

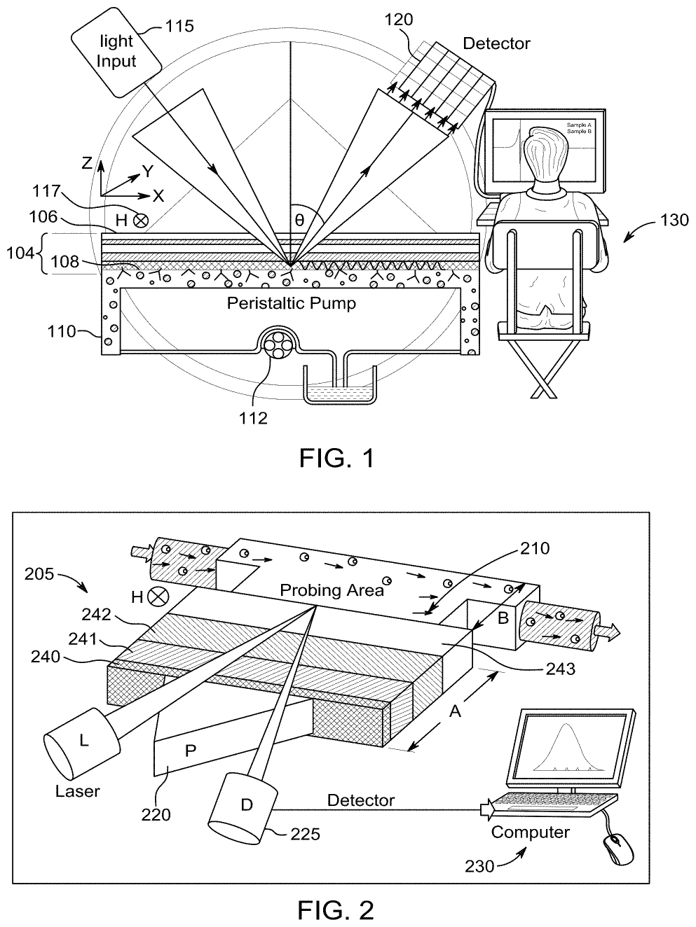

Referring now to FIG. 1, a schematic drawing of a sensor that uses SPR techniques is depicted. This configuration includes sensor film element 104 which has a first surface 106 exposed to air/prism and a second surface 108 exposed to a sensing channel or flow cell 110. In this configuration, probing samples are provided in media that may include gases, vapor molecules and liquid media which are pumped through flow cell 110 using a peristaltic pump 112. The detection process uses incident optical radiation (at different wavelength λ and incident angles, θ) provided by light source 115. In addition, using variable input power, and magnetic activities, all the interaction processes occurring at the air or liquid interfaces and are then converted into a detectable electric signal using a photo-detector 120. Signals from the photo-detector 120 are then transmitted to processor 130.

In the system disclosed, a right-angled prism is used for the excitation of the surface plasmons. The circle with a cross symbol 117 is the notation showing the direction of the applied magnetic field H on the MOP film. Both air and Helium were used as the probing samples.

The configurations disclosed here include the effect created by the adhesion layer, which although may introduces losses, it is often necessary for reliable fabrication, and they are composed of thin plasmonic layers on the side of the sensing surface, which is opposite to a typical or conventional arrangement.

The complex optical constants of all the materials were obtained from Johnson, P.; Christy, R. Optical constants of transition metals: Ti, V, Cr, Mn, Fe, Co, Ni, and Pd. Physical 206 review B 1974, 9, 5056. See also Rizal, C.; Belotelov, V. I. Sensitivity comparison of surface plasmon resonance (SPR) and magneto-optic 185 SPR biosensors. Eur. Phys. J. Plus 2019; Rizal, C.; Pisana, S.; Hrvoic, I. Improved magnetooptic surface plasmon resonance biosensors. Photonics 187 2018. The optical constants are refined using the experimental results by fitting the data to the model.

The outer or base 8 nm Au layer also works as a capping layer for both the configurations (Configurations A and B). The total thickness of the multilayer was chosen/optimized to match the thickness of a single Au layer that gives the best result.

Now referring to FIG. 2, a sensing configuration is depicted that includes, the senor element comprised of film 205 and sensing channel 210. Sensing channel 210 is part of the flow cell 212 through which probing samples are injected for detection using the indent optical radiation at different wavelengths λ and incident angles Θ, input power and magnetic activities where all the interaction processes occurring at the interfaces are converted to into detectable electric signals using a photo-detector and processor. Surface plasmons are excited using right-angled prism coupler 220. The metallic film sensor configuration depicted consists of a first layer 240 made of 2 nm Ti and index matching liquid (IMD), a second layer 241 made of 35 nm of Ag, a third layer 241 made of 4 nm of Co and a further layer 243 made from 10 nm of outer plasmonic Au layer. A detector 225 measures reflected radiation and transmits a signal to processor 230 for analysis.

The multilayered configurations were fabricated using a deposit technique using electron beam (“e-beam”) evaporation on BK7 glass using four crucibles. In the embodiments disclosed, the films were deposited in a single deposition run without breaking vacuum. A characterization performed at the time of fabrication included the verification of the film thickness using atomic force microscopy. The deposition rates were 1.2, 0.7, 0.5 and 0.7 As-1 for Ti, Au, Ag, and Co, respectively. The e-beam evaporation method used to create the films offered structural and morphological control of the materials. Each metal has different deposition rates and these rates were optimized to obtain appropriate smoothness, crystallinity, and layer thicknesses. The outer base 4 nm Au layer also acts as a capping layer and prevents surface oxidation for the fabricated material. In other embodiments a further layer with 0 to 15 nm thick inert polycarbonate laminate plastic is also provided as protective layer. It has been found that the higher sensitivity and improved performances shown by the MO-based SPR sensors, several technical challenges still prevail such as oxidation of sensor surface leading to degradation of performance, issues with reproducibility of the sensor surface due to the difficulty of removing adsorbed materials, and scratching of sensor surface during cleaning. In addition to the composition and layer thickness, interface roughness between each layer of the sensor configuration also plays critical roles in defining MO effect and sensitivity of the sensor. A protective polycarbonate layer does not significantly compromise the MO enhancement and sensitivity. The magneto-optic plasmonic (MOP) sensor is described using classical electromagnetic theory: reflection, transmission, and absorption of the optical radiation. The configurations shown were optimized using COMSOL Multiphysics software—the finite element method and transfer matrix method. COMSOL is a simulation platform that encompasses all of the steps in the modeling workflow from defining geometries, material properties, and the physics.

The magneto-optic plasmonic (MOP) sensors disclosed—such as the multilayer configuration shown in FIG. 2—are described using classical electromagnetic theory: reflection, transmission, and absorption of the optical radiation. The configurations shown were optimized using COMSOL Multiphysics software, using a finite element method and transfer matrix method. COMSOL is a simulation platform that encompasses all of the steps in the modeling workflow from defining geometries, material properties, and the physics.

The wavelength, λ dependent permittivity's, linear (e) and non-linear (magneto-optic (εₘₒ)) were used for the simulation. The applied magnetic field (H), is considered transverse direction (parallel to the sensor surface and perpendicular to the plane of incidence) whose dielectric permittivity tensor can be given as

$$ɛ = [ \begin{matrix}{ɛ}_{0} & {ɛ}_{mo} & 0 \\ - {ɛ}_{mo} & {ɛ}_{0} & 0 \\ 0 & 0 & {ɛ}_{0}\end{matrix} ]$$

where ε₀ is the permittivity of the multilayer at H=0 and εₘₒ is the magneto-optic constant due to the applied H field (H=H). The ϵₘₒ is quadratic function of the field.
The constants for the optical parameters at 632.8 nm, BK-7 (2.2940+j00), Ti (−6.866+j20.36), Au (−11.13+j1.327), Co (−12.48+j18.45) and emo (−0.65+j0.0005), He (1.00006977), air (1.0005530), and δn632.8 (0.000483) and at 785 nm, BK-7 (02.28+j00), Ti (−06.51+j24.81), Ag (−29.79+j00.3), Co (−16.43+j23.38), and emo (−0.85+j0.0006), Au (−22.86+j01.43), He (01.00006960), Air (01.00055020), and δn785 (0.000483).

The optical parameters were further refined using the experiment by fitting the experimental data to the theory/model. The model consisted of six layers as: Prism (BK7), Ti, Ag, Co, Au, and probing samples (air or Helium). The effect of external magnetic, H field and excitation λ on SPR and sensitivity were included in the calculation.

For the p-polarized incident light input through the triangular prism as illustrated in FIG. 2, an evanescent wave is created whose amplitude is decayed exponentially normal to the sensor interface. A resonance occurs when the wave-vector of the incident light (kx,0) matches to the wave-vector of the surface plasmon K_{SPP}, and they are given as:

$${k}_{SPP} = \sqrt{\frac{ω}{c} \times \frac{( {ɛ}_{d} {μ}_{d} \times {ɛ}_{m} {μ}_{m} )}{( {ɛ}_{d} {μ}_{d} + {ɛ}_{m} {μ}_{m} )}}$$

where ω is the angular frequency, c is the velocity of light in vacuum, and ϵ_{d}, μ_{d} and ϵₘ, μₘ are the dielectric permittivity and magnetic permeability functions, respectively. This is done using a right-angled prism as shown in FIGS. 1 and 2. Another important parameter for the sensitivity study is the resonant angle θ_{SPR}.

The sensitivity of a biosensor is a critical parameter for its bench marking. However, given the nature of a wide variety of biosensors (e.g., chemical, mechanical, electronic biosensors, humidity sensor, NO₂ sensors, poisonous gas sensors, etc.) currently being studied, and whether or not chemical, biological or physical changes are being recorded and/or the localized or propagating SPR are being studied, there is no unified sensitivity metrics available to quantify and compare the performance of each of these biosensors. The new sensitivity metrics are defined as:

$$\begin{matrix}{S}_{SPR} = \frac{Rp ( A ) - Rp ( B )}{Rp ( A ) m} and & ( 3 ) \\ {S}_{MOSPR} = \frac{dRp ( A ) - Rdp ( B )}{dRp ( A ) m} . & ( 4 )\end{matrix}$$

More importantly, since the sensitivity of SPR sensors has been defined differently than the sensitivity of the MOSPR sensors, using the conventional sensitivity definition, we are not able to accurately compare the performance of these sensors side by side. Realizing this problem, new sensitivity benchmark metrics were used to allow the comparison of the performance of SPR sensors to MOSPR sensors.

Unlike the SPR signal, which depends on the magnitude of Rp, the magnitude of the MOSPR signal depends not only on the relative change in Rp for the p-polarized incident light, but on the relative change in dRp (between the air and Helium media) as well as the derivative of the dRp curve and absolute |dRp| value. This means that the magnitude of the MOSPR signal relies on the characteristics of the plasmon resonance curve as well as the variation of plasmon dispersion due to the opposing magnetic fields (H±/M±). Note that the sign of the εₘₒ is taken as positive for the clockwise rotation of the co-ordinate system when viewed along the z-axis and that the z-axis is directed along the H/M direction. The detection limit, D is also defined differently in literature for example, in atomic absorption spectrometry analysis, a diluted solution is analyzed, and the corresponding absorbance is recorded. Another example would be in chemical sensing, where D is defined as the lowest quantity of a substance that can be distinguished from when no sample is present. In most measurements, D is the smallest concentration of either gas or liquid media that generate signals, which are at least 3× more than the instrumental noise, i.e., the 3× the standard deviation, σ of the recorded absorbance signal. Mathematically, D can be represented as: D=s₀+3×σ, where s₀ is the instrumental noise. However, the problem with the above-mentioned definitions is that D is not unique, and the performance of two different sensors are not comparable. Moreover, D can vary depending on the type of noise contribution taken into account during the measurement, and whether or not the instrument is calibrated prior to it. In the current work, D is defined as: D=σS where, σis the standard deviation of the noise (≈5.0×10⁻⁴) and S is the sensitivity, expressed in %/RIU. Note that D can slightly vary depending on the instruments used and the noise they render during measurements. Although D of the sensor can be improved by modulating λ, amplitude, phase or angle of incidence, in the present case of the MOSPR sensor, it is the H field that is used to modulate and improve D. The size, shape, slope, and intensity of the SPR and MOSPR curves and thus, the detection limits are primarily dependent on these parameters.

For the reflectance and T-MOKE characterization a laser diode from Thorlabs QL7816S-B-L, Germany, was used to generate a linearly p-polarized light. The laser wavelength was tuned via temperature control of the module with an accuracy of 0.01 K and was controlled using a Horiba HR-320 spectrometer. The optical radiation was then collimated and focused using spherical and cylindrical lenses with f=150 mm and 18 mm, respectively. The reflected radiation was collected using a monochrome CMOS matrix camera, IDS UI-3360CP-M-GL, having 2048×1088 px screen (11.264 mm×5.984 mm screen dimension), yielding a 5.5 μm pixel size. The MOP samples were placed inside an electromagnet (H˜≈30 mT) with the inter-polar gap of 30 mm in transverse Kerr geometry (orthogonal to the plane of incidence), and controlled via LabVIEW program to record the real-time reflectance angular spectra as well as the T-MOKE spectra. Air with 30% humidity was blown at atmospheric pressure and room temperature of 21.6° C.

The optical radiation is incident on the prism with a roughly 3° diverging beam centered around the resonant surface plasmon excitation angle. For both reflectance and T-MOKE effect, angular interrogation is used with the incident angle varied between 39-43° as collected by the CMOS camera. For the T-MOKE study, the multilayers were magnetized in the transverse direction (as indicated by the direction of H in FIGS. 1 and 2).

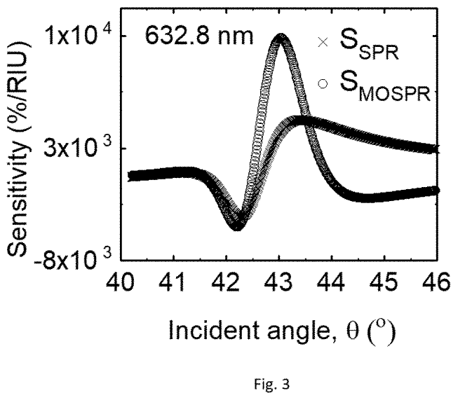

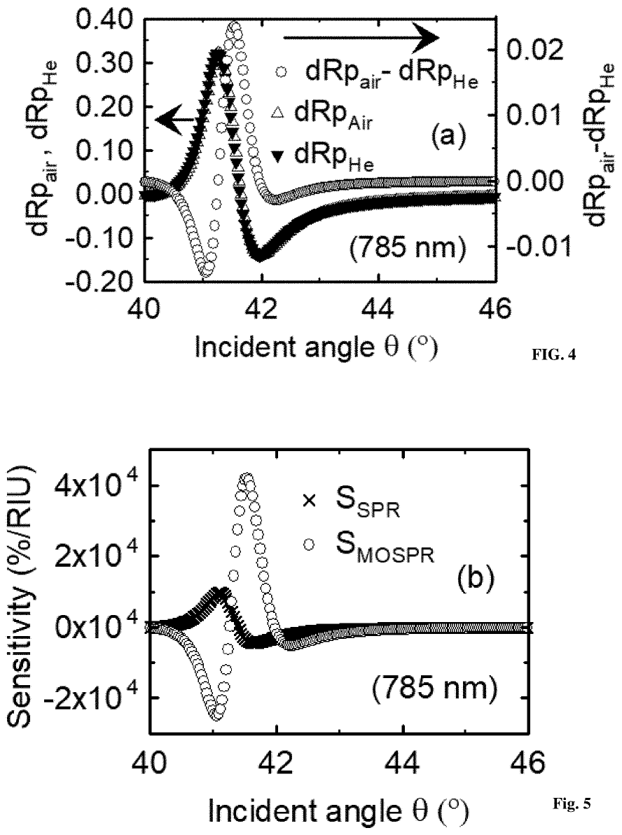

The effect of excitation λ on the sensitivity has been studied here. FIG. 3 shows modeled SPR and MOSPR sensitivities of the Ag-based Ti/Ag/Co (4 nm) sensor as a function of θ, calculated (using sensitivity metrics (3) and (4) as described above), at λ=632.8 nm. FIG. 4 shows modeled SPR and MOSPR sensitivities of the Ag-based Ti/Ag/Co (4 nm) sensor as a function of θ, calculated (using sensitivity metrics), at λ=785 nm (the sensing media was changed from air to Helium). These are common wavelengths for plasmonic metals, due to the low losses incurred in these wavelengths as compared to the losses incurred, for example at λ=532 nm or lower. As shown in FIG. 3 the curve for 632.8 nm is broader compared to the curve of FIG. 4 for 785 nm. This is considered due to the losses inherent at the lower λ. However, based on simulations carried out in this work and prior experience, the benefits from the magnetic activity are overwhelmed by the optical losses. Also, the MOSPR/TMOKE sensitivity obtained using (3) and (4) show improvement by 2.5× and 3.5× over the SPR sensitivity at the excitation λ=632.8 and 785 nm, respectively.

Now referring to FIG. 5, the change in reflectivity, dRp (dRpair, dRpHe), due to the applied magnetic field, H as a function of the incident angle for optimized configuration. FIG. 5 shows SPR vs. MOSPR sensitivity of an Ag-based Ti/Ag/Co(4 nm) (air to Helium) sensor expressed in %/RIU: (SPR) and (MOSPR) at 784 nm. The modeled transition between the probed media air and Helium is an indicative of the relative response of the biosensors. Note the position of an excitation angle, θSPR, maximum value, as well as the curve shapes/slopes that change with the excitation wavelengths in FIG. 3 at a λ632.8 nm and FIG. 5 at a λ785 nm. IMD=index matching liquid. Here the change in reflectivity due to the applied magnetic field, H as a function of the incident angle for optimized configuration of Ag-rich Ti/Ag/Co(2 nm)/Au(4 nm). The modeled transition between the probed media air and Helium is indicative of the relative response of the MOSPR biosensors.

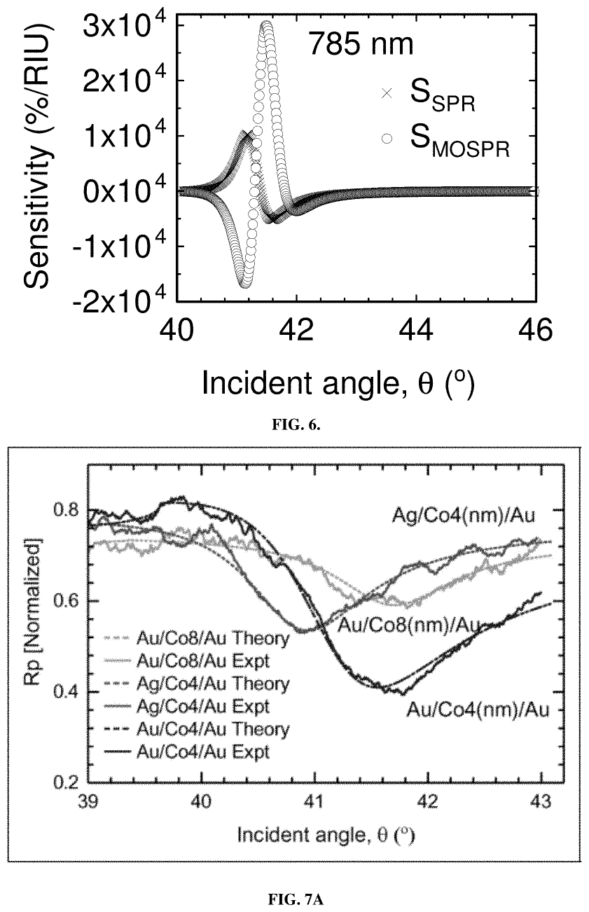

FIG. 6 depicts the change in reflectivity, dRp=[Rp(H)−Rp(0)] wherein the inset shows the enlarged view for an optimized sensor configuration of Ag-based Ti/Ag/Co (4 nm)/Au (4 nm)/(air to Helium). Here the change in reflectivity due to the applied magnetic field, H as a function of the incident angle for optimized configuration of Ag-rich Ti/Ag/Co(2 nm)/Au(4 nm). The modeled transition between the probed media air and Helium is indicative of the relative response of the MOSPR biosensors.

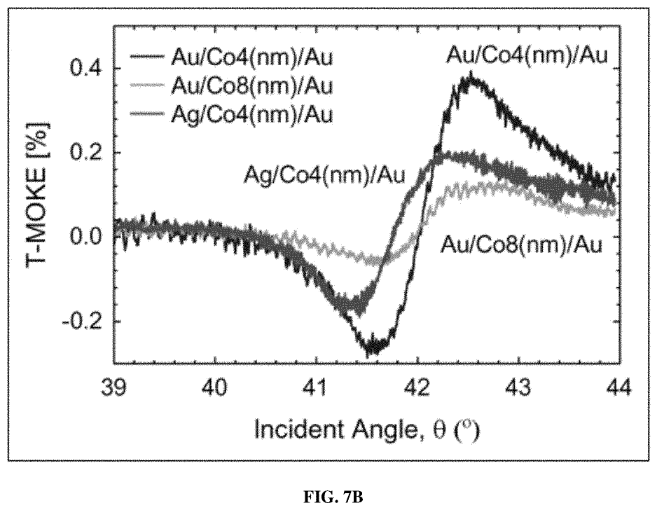

FIGS. 7A and 7B show the theoretical SPR curves fitted to the experimental data by adjusting the optical constants of the layers. The experimental line width, Δθ(full-width at half maximum) of the SPR curves for (a) Au/Co (8 nm)/Au/air, (b) Au/Co (4 nm)/Au/air and (c) Ag/Co (4 nm)/Au/air are 1.2, 0.8 and 0.6°, respectively and these give the quality factor, Q_{SPR}=Δθ_{SPR}/θ as 46, 52 and 67, respectively (highest for the Ag/Co (4 nm)/Au/air configuration, denoted as Configuration B). As shown in FIG. 7A, the SPR curve is much broader than the MOSPR curve shown in FIG. 7B. This can be attributed to the higher losses inherent a the lower λ. However, based on simulations (and the results shown in FIG. 7B), the benefits from the magnetic activity are overwhelmed by the optical losses. The MOSPR curve is much sharper and the magnitude are also amplified by over 2.5× to 3× larger compared to the magnitude of the SPR at this λ.

Still referring to FIGS. 7A and B, the SPR and MOSPR characteristics as a function of θ obtained at 785 nm is depicted. As shown, the MOSPR sensitivity curve is much sharper when compared to the SPR sensitivity curve. Likewise, the MOSPR amplitude is almost 3× larger than the SPR amplitude. The sensitivity of a sensor is maximized near the resonance angle, θ_{SPR} where the R_{P} is mostly amplified. In order to achieve this, we need to optimize the sensor configuration. Below, it is shown that by optimizing the plasmonic Au magneto-optic Co layers, both the SPR and MOSPR sensitivity and thus, the detection limit is significantly improved.

The shape of the reflectance curve (Lorentzian) is determined by the mode propagation constant. The real and imaginary parts of the propagation constant can be determined by the SPR angle and resonance width as Re[β]=k0n sin(θSPR), and Im[β]=0.5 k0n Δθ cos(θSPR), respectively.

The detection limit, D (determined using the experimentally refined theoretical parameters and experimental noise value) of the SPR and MOSPR sensors are listed in Table 4.

TABLE 4
DETECTION LIMIT (D) OF THE SPR AND MOSPR SENSORS
AT λ = 632.8 AND 785 NM, RESPECTIVELY.
NOTE THE THICKNESSES OF TOP A [symbol] AND MIDDLE CO LAYERS.

| | D_{SPR} (RIU) | | D_{MOSPR} (RIU) | |
|---|---|---|---|---|
| Material, [symbol] (nm) | 632.8 nm | 785 nm | 632.8 nm | 785 nm |
| Au(10)/Co(4)/Ag(35)/ | [symbol] .30 × | 1.55 × | 1.76 × | 1.67 × |
| Ti(2) | 10⁻⁵ | 10⁻⁶ | 10⁻ [symbol] | 10⁻ [symbol] 14 [symbol] |
| Au(8)/Co(4)/Au(35)/ | 4.30 × | 1.05 × | 1.26 × | 1.51 × |
| Ti(2) | 10⁻⁵ | 10⁻⁶ | 10⁻ [symbol] | 10⁻ [symbol] work [symbol] |
| Au(4)/Co(2)/Ag(35)/ | — | — | 2.05 × | 7.10 × |
| Ti(2) | | | 10⁻ [symbol] | 10⁻ [symbol] work [symbol] |

[symbol]

indicates data missing or illegible when filed

The D obtained for the optimized sensor configuration is ≈7.10×10−6 RIU. This value is comparable (slightly higher) to D for the MOSPR sensors coupled to a photonic crystal.

The enhancement of MOSPR effect clearly prevails in Ag-rich structures at both visible and IR excitation wave-lengths and is more prevalent at IR λ=785 nm. The ease of calculating/measuring changes in reflectivity vs. θ, sharp resonance peak, and enhancement in detection limit make MOSPR sensors very promising for early disease detection. The detection limit can be further improved by optimizing the excitation λ, modifying light-matter coupling, improving measurement schemes, and reducing the detection noise of the instruments involved. By further optimizing the Co layer thickness to 2 nm, both the sensitivity and detection limit may be further increased.

The fact that the Ag layer in the multilayer leads to a narrowing of the resonance in the reflectance curve, as indicated by the lower Δθ and higher Q-factor, is an indication of the lower optical losses (higher conductivity) of Ag. Using Ag for the inner plasmonic layer provides higher Q-factor but cannot be used without an additional capping layer for the external plasmonic layer to avoid oxidation. The outer Au layer is in contact with the probing sample, in this case, air.

Two types of SPR configurations based on 4 or 8 nm of Co and Au versus Ag layers were presented and obtained the quality factor for two plasmonic sensing schemes (SPR versus T-MOKE). While the ferromagnetic Co introduces some losses for the SPR spectra, the T-MOKE response obtained overrides this loss. Magneto-optical non-reciprocity becomes more significant in these structures leading to an increase in the magnitude of the transverse Kerr effect and thus, the Q-factor. The advantage of the T-MOKE sensor over the existing SPR based sensors is significant.

As identified by SPR and MOSPR characteristics, the magneto-optic-plasmonic configuration disclosed show improved sensitivity and detection limit (D) at both the visible and near infra-red (IR) wavelengths λ. The sensitivity measured at 785 has higher sensitivity than when measured at 632.8. In addition, the results show that when the top AU layer is reduced, the sensitive and detection limit are even higher. The samples studied were continuously passed through the sensor for about 10 seconds at the same speed and the measurement was recorded. The recorded data in this case is not a function of measurement time. Despite the optical loss incurred by the metals, the magnetic activity significantly enhanced the MOSPR sensitivity and detection limit at both wavelengths and almost 4× higher at IR. These results are considered significant and can form the benchmark for studying the performance of a wide variety of biosensors currently being developed or will be developed in the near future. The calculated D is ≈7.10×10⁻⁶ RIU (refractive-index-unit) at 785 nm, which is also larger than the optimized MOSPR sensors coupled to a photonic crystal.

The foregoing description of the present invention has been presented for purposes of illustration and description but is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

1. An improved multilayered magneto-optic-plasmonic (“MOP”) film used in connection with surface plasmon detection, said film comprising: a first layer comprising titanium, a second layer selected from a group consisting of gold and silver, a third layer comprising cobalt, and a fourth layer comprising gold.

2. The improved MOP film of claim 1 wherein
said first titanium layer has a thickness of approximately 2 nm,
said second layer is comprised of gold and has a thickness of 35 nm,
said third cobalt layer has a thickness of approximately 4 nm and
said forth gold base layer has a thickness of approximately 8 nm.

3. The improved MOP film of claim 1 wherein
said first titanium layer has a thickness of approximately 2 nm,
said second layer is comprised of silver and has a thickness of 35 nm,
said third cobalt layer has a thickness of approximately 4 nm, and
said forth gold base layer has a thickness of approximately 8 nm.

4. The improved MOP film as recited in claim 1 wherein
said first titanium layer has a thickness of approximately 2 nm,
said second layer comprise silver and has a thickness of 35 nm,
said third layer comprises cobalt and has as thickness of approximately 2 nm and
said fourth layer is gold and has a thickness of approximately 4 nm.

5. The improved MOP film as recited in claim 1 wherein
said first titanium layer has a thickness of approximately 2 nm,
said second layer comprise silver and has a thickness of 35 nm,
said third layer comprises cobalt and has as thickness of approximately 2 nm and
said fourth layer is gold and has a thickness of approximately 10 nm.

6. The improved MOP of claim 1 wherein the further layer, said fifth lawyer adjacent to said forth Au layer is comprised of polycarbonate having a thickness of between 2 and 15 nm.

7. A system for the measurement of an analyte using surface plasmon resonance, said system comprising;
a flow cell for transporting a fluid analyte said flow cell having an inlet port, a chamber comprising walls and an exit port and said flow cell further comprising a multilayered magneto-optic-plasmonic (“MOP”) film said film having a first surface in defining a wall of said chamber, said multilayer film further comprising
a first layer comprising titanium having a thickness of approximately 2 nm,
a second layer comprising a material selected from a group consisting of gold and silver, said material having a thickness of approximately 35 nm,
a third layer comprising cobalt having a thickness of between 2 nm and 4 nm, and
a fourth layer comprising gold having a thickness of approximately 10 nm;
said system further comprising;
a light source,
a photodetector, and
a processor,
wherein said light source is directed at said multilayered MOP film surface and incident angle and light reflected from said film surface is directed to a detector, and said detector creates a signal, and said signal is transmitted to said processor, and said processor compares said signal to a baseline signal and provides an output.

8. The system of claim 7 wherein said fluid comprises a liquid analyte.

9. The system of claim 8 further comprising a pump wherein said pump moves said liquid analyte through said flow cell.

10. The system of claim 7 wherein said light source comprises a prism and the wavelength directed to said film surface can be varied.

11. The system of claim 7 wherein the incident angle that light is directed to said MOP film surface is variable.

12. The system of claim 7 further comprising means to variably apply a magnetic field to said MOP film.

13. A method of measuring for a target agent present in an analyte, said method comprising,
preparing a first surface of a MOP film with receptors that can bind with said target agent, wherein said MOP film comprises, a first layer comprising titanium having a thickness of approximately 2 nm , a second layer selected from a group consisting of gold and silver and having a thickness of approximately 35 nm, a third layer comprising cobalt having a thickness of between 2 and 4 nm, and a fourth layer comprising gold having a thickness of approximately 10 nm , and
preparing a first standard fluid as a baseline,
preparing an analyte comprising said target agent,
preparing said forth base layer with an agent selected to bind with said target analyte,
incorporating said MOP film to a flow cell adapted to receive said analyte,
directing a light source at an opposite surface of said MOP film,
introducing said standard fluid to said flow cell,
measuring the light reflected from said film to create a first signal,
introducing said analyte comprising said target agent to said flow cell,
measuring the light reflected from said film when or after said target analyte has passed through said flow cell to create a second signal.

14. The method of claim 13 wherein said light from said light source has a wavelength of 780 nm.

15. The method of claim 13 wherein said light from said light source has a wavelength of 780-785 nm.

16. The method of claim 13 further comprising the application of a magnetic field to said MOP film.

17. The method of claim 13 wherein said probing sample is in liquid.

18. The method of claim 13 wherein said probing sample is helium.

19. The method of claim 13 wherein said probing sample is air.
